(19) United States
(12) Patent Application Publication
(10) Pub. No.: US 2007/0160972 A1
(43) Pub. Date: Jul. 12, 2007

(54) SYSTEM AND METHODS FOR REMOTE INTERACTIVE SPORTS INSTRUCTION, ANALYSIS AND COLLABORATION

(76) Inventor: John Jay Clark, Boynton Beach, FL (US)

Correspondence Address: John Jay Clark, 8934 Indian River Run, Boynton Beach, FL, 33437, US

(21) Appl. No.: 11/306,802

(22) Filed: Jan. 11, 2006

(51) Int. Cl. G09B 7/00

(52) U.S. Cl. 434/362

(57) ABSTRACT

A system and methods for an interactive remote sports instruction, analysis and collaborative session between an instructor and students over a network connection on a LAN, WAN or Internet connection. This system consists of a combination of collaboration technologies such as video conferencing, voice, text messaging, synchronized video playback and positioning, synchronized annotation and drawing over video, file sharing and transferring and remote mouse pointer control. The system provides methods for the student to choose an instructor based on their credentials, schedule an instructional session and collect and remit fees for the instructor.

### BACKGROUND

Currently methods to provide remote sports instruction over the Internet rely on the uploading of video files or other data files to a web portal. The video files recorded by the student are uploaded by the student or by an agent of the company providing the analysis. In most cases, the instructor may be notified by e-mail that videos are uploaded for analysis or the instructor may log on to a web portal to check for new video arrivals. The instructor performs the analysis on the video or data and posts the results back to the web portal. The student is notified by web portal that the analysis is complete. He must log back on to the web portal to review the analysis. In some cases, the student can communicate with the instructor by leaving messages on the web portal or using e-mail. In most cases there is a usage cost associated with using the web portal borne either by the instructor or student.

These methods, as presented above, are designed to replace or supplement one-on-one personal instruction. However, these methods of remote instruction have many drawbacks. The length of time to receive the analysis or feedback can be several days to weeks. Questions posed by the instructor or student are posted through the web portal or by email. In most cases, it takes one to several days to complete a correspondence on a particular question or issue. The instruction is non-interactive, in other words; the student can simply view the analysis but can not significantly interact with it or the instructor. This type of instruction is very inefficient and time consuming. There is a need, therefore, for a more efficient and interactive way to handle remote instruction and to provide live and real-time collaborative instruction between the instructor and student.

### SUMMARY

The following simplified summary provides a basic overview of some aspects of the present technology and embodiments of the invention. This summary is not an extensive overview. It is not intended to identify key or critical elements or to delineate the scope of this technology. This Summary is not intended to be used as an aid in determining the scope of the claimed subject matter. Its purpose is to present some simplified concepts related to the technology before the more detailed description is presented below.

The present technologies widely used for remote teaching is a web portal model. Video or data may be posted to the web site for analysis by an instructor. The instructor would download the video from the web portal and use a system to do the analysis. There is usually no interaction between the instructor and student as the instructor is doing the analysis. The analysis is solely based on the video or data at hand and may be missing important feedback from the student that would aid in the analysis and the diagnosis of problem areas.

With the present technologies, the time it takes for the student to receive the analysis may be several days to weeks. After reviewing the analysis, the questions the student may have usually are communicated to the instructor through the web portal or e-mail. Again it may be one to several days before the student will receive a response to his questions.

Accordingly, embodiments of the invention overcome one or more deficiencies of the present technology by employing technologies to provide a collaborative remote instructional session between an instructor and student. These technologies may include but are not limited to the following: video, voice and text communication over an IP network or any other network capable of carrying voice and data, real-time synchronized control over the local and remote video, the ability to provide synchronized annotation capabilities such as drawing shapes, freehand or text real-time over the local and remote video, remote mouse control to be used as a remote pointing device, peer-to-peer file transfer and remote video capture. The combined use of these collaborative technologies to create a real-time interactive instruction session between the student and instructor is the embodiment of the present invention.

The connection between the instructor computer and student computer may be a LAN or WAN network consisting of a client/server connection or a proxy connection through a remote server. The invention will have embodiments of several different levels of utility for instructor and student collaboration. The invention will also have embodiments for a mechanism for instructors to be selected by students based on the instructor's credentials and handle all scheduling and payment aspects between the student and instructor.

### BRIEF DESCRIPTION OF DRAWINGS

FIG. 1-2 is a perspective of an exemplary software interface that embodies the technologies of the invention.

FIG. 3 is a diagram of exemplary collaborative technologies of the present invention.

FIG. 4 is a diagram of exemplary methods of connectivity of the present invention.

FIG. 5 is a diagram of another exemplary method of different levels of utility for instructor and student collaboration embodied in the present invention.

Corresponding reference characters indicate corresponding parts throughout the drawings.

### DETAILED DESCRIPTION

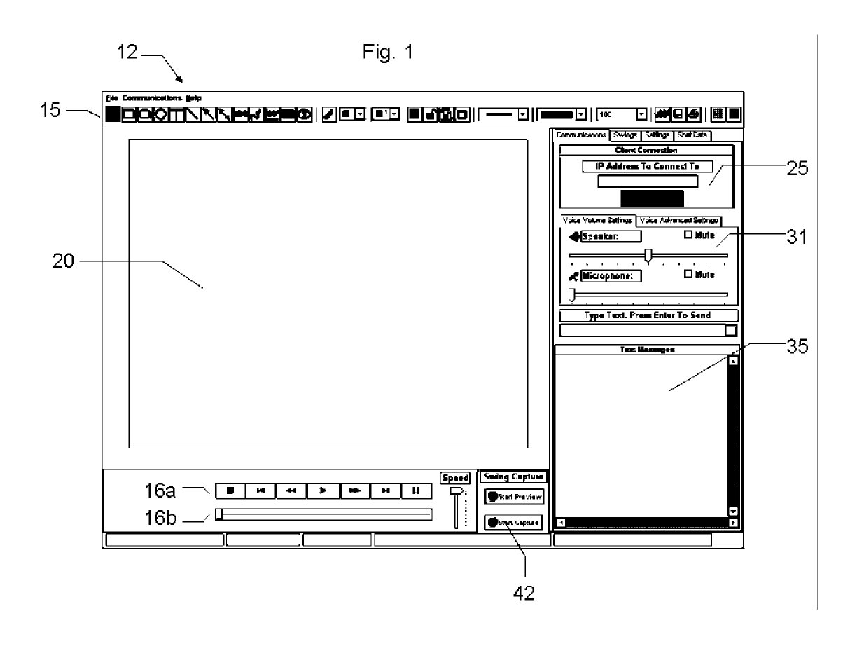

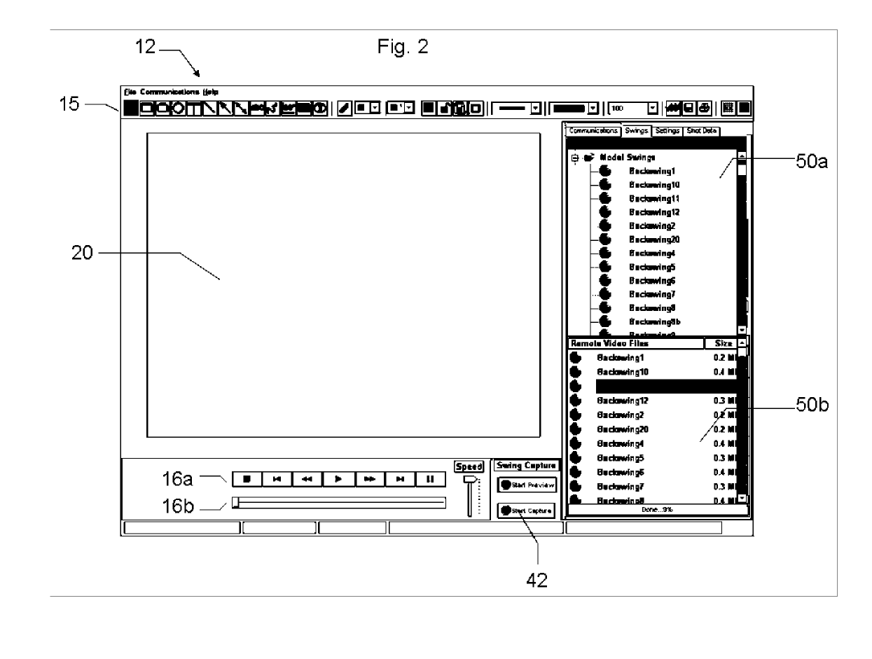

Collaborative Technologies: In the embodiment depicted in FIGS. 1-5, several collaborative technologies are used in conjunction to provide a real-time, interactive instructional session between the student and instructor. The invention consists of a user interface 12 for collaboration and the ability to provide network connectivity 200 from the student to the instructor. The invention may be comprised of but not limited to the following collaborative technologies 100.

According to aspects of the invention, it will comprise video, voice 120 and textual collaboration 122 capabilities. The video collaboration 120 can include two-way real-time live video using web cameras. Voice collaboration 120 can include Voice over IP (VoIP), so the instructor and student can verbally communicate during the instructional session. Textual collaboration 122 can include two-way text messaging. In the example of sports instruction, the student establishes a connection to the instructor. Once connected the student and instructor can converse using a microphone attached to the computer. They could also send text messages by typing the message into the user interface.

According to aspects of the invention, it will also comprise synchronized annotation 127 capabilities. As the instructor or student draws shapes, freehand or text on the video, the drawings are automatically synchronize for both the instructor and student. In the example of sports instruction, the instructor draws a circle on the video to highlight an area, that circle is immediately displayed on the student's video. Then if the student moves the circle drawn by the instructor to highlight another area, the circle is immediately moved on the instructor's video.

According to aspects of the invention, it also comprises the ability to select, remotely control and synchronize the playback and frame position of the instructional video 125 by both the instructor and student. In the sports instruction example, the instructor positions the video to a point of interest; the student's video is immediately moved to the new position. The student then moves the video to a different position; the instructor's video is immediately moved to the new position.

According to the aspects of the invention, it also comprises the ability to transfer video files or any other data files 129 used for instruction and analysis purposes. The student may transfer files to the instructor or transfer files from the instructor. In turn, the instructor may transfer files to the student or transfer files from the student. In the sports instruction example, the student has captured video to be analyzed by the instructor. The student transfers the video file and a related statistical data file to the instructor to be analyzed during the current session.

According to the aspects of the invention, it also comprises the ability for the instructor or student to control the remote mouse pointer 126. The mouse pointer can be used as a remote pointing device to further aid in instruction. In the sports instruction example, the instructor locks the remote mouse pointer to match the movement of his mouse pointer while on the video screen. The instructor uses the remote mouse pointer to point to desired points on the student's video.

User Interface: In the embodiment depicted in FIG. 1, the invention comprises a user interface. The user interface 12 incorporates the presentation and interactive layer of the collaborative technologies 100 used in the invention. The user interface will consists of areas of distinct functionality that is correlated to specific collaborative technologies 100. These areas may include but are not limited to the viewing of video 20, video playback control 16, voice collaboration settings 31, text messaging area 35, video annotation and drawing 15 and file transfer 50.

According to the aspects of the invention, the user interface 12 will be comprised of a window to display the video 20 to be analyzed. Playback controls will be provided to play 16a or position 16b the video. The instructor and student video will be synchronized by using the playback controls 16.

According to the aspects of the invention, the user interface 100 will also be comprised of an area to control the voice settings 31. This area may control the speaker and microphone boost and volume.

According to the aspects of the invention, the user interface 100 will also be comprised of an area to send text messages 35. After typing in a line of text, the text message will be sent to the instructor if initiated by the student and to the student if initiated by the instructor.

According to the aspects of the invention, the user interface 100 will also be comprised of an area to select annotation or drawing tools 15 and provide a method to draw over the video being analyzed. The drawings are synchronized between the instructor and student.

According to the aspects of the invention, the user interface 100 will also be comprised of an area to transfer files 50. These files may be video file to be analyzed or any other data file that will be used in the analysis. The file transfer can be initiated by both the instructor 50a and student 50b to either send or receive files.

According to the aspects of the invention, it also comprises a network connectivity 100 function for the collaborative technologies. As would be understood by one skilled in the art, network connectivity between the student and the instructor can be on a Local Area Network (LAN) or a Wide Area Network (WAN). An example of a WAN is the Internet. Network connectivity may be a Client/Server 200 model where the students 201 and instructors 205 computers communicate directly with each other over a LAN or WAN. Network connectivity may be a proxy model 210 where the students 241 and instructors 245 computers communicate through a remote computer known as a proxy server 251. The invention may embody many different communication protocols widely available such as TCP/IP, UDP or HTTP and may be offered as a stand alone computer application or as part of a web browser interface using HTML, Java, Java Script or any other language or tool suitable for such a purpose.

Accordingly to the aspects of the present invention, it may embody a web portal 251 for the purpose of finding instructors based on credentials, handle all scheduling and collection and remittance of fees in association with the interactive instructional session. In the sports instruction example, a student wishing to improve his golf swing may access the web portal and query the instructors based on different criteria to select the instructor that best fits the needs of the student. Through the web portal 251 the student schedules a lesson with the instructor and pays any applicable fees associated with the interactive instructional session. At the pre-determined scheduled time the instructor and student initiate the interactive instruction session through the web portal 210 or by a client/server 200 or peer-to-peer 210 connection on the internet or other WAN or LAN.

### Methods

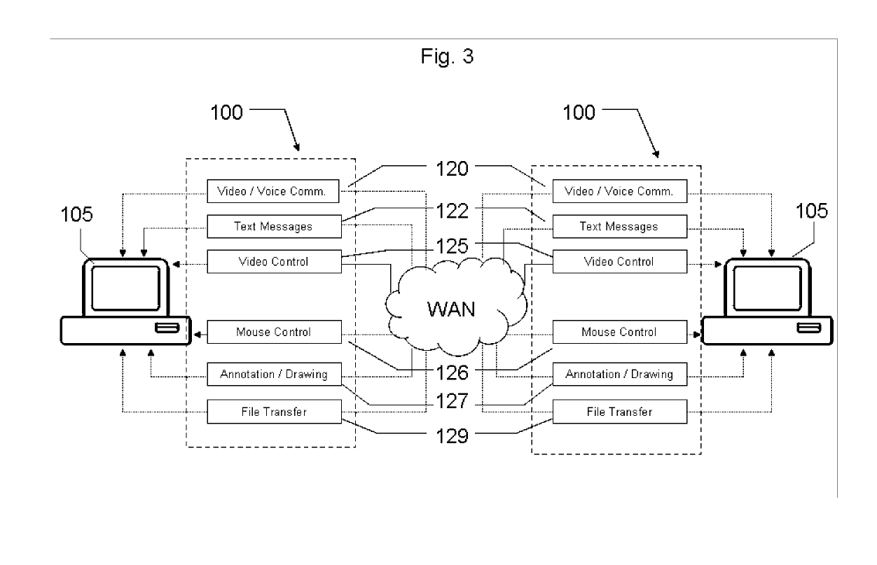

Another embodiment of the present invention depicted in FIG. 3 comprises a method of providing voice collaboration 120 over the network. Using the microphone and speakers attached to the computer or headset, a highly compressed voice stream is sent back and forth over the network connection. Voice communications are full duplex so the voice communications are similar to a telephone conversation.

Another embodiment of the present invention depicted in FIG. 3 comprises a method of providing text messages 122. Text based messages are typed in to the program. On completion of a line the text message is sent to the remote program and displayed in the conversation box.

Another embodiment of the present invention depicted in FIG. 3 comprises a method of providing synchronized video playback and frame positioning 125. By using the playback controls 16a-16b video positioning messages are passed back and forth over the network connection to keep the video synchronized. This method is much more efficient than sending a graphics representation of the screen over the network as many remote control programs do. This method can provide real-time video interaction even over slower dialup connections.

Another embodiment of the present invention depicted in FIG. 3 comprises a method of providing synchronized video annotation 15. Drawing on the video generates drawing messages that are passed back and forth over the network connection to keep the drawings in sync. To prevent collisions in the case where the student and instructor simultaneously make drawing changes, drawing is disabled on the remote system until the drawing is completed on the local system and the remote drawing is synchronized.

Another embodiment of the present invention depicted in FIG. 3 comprises a method of providing file transfer 129 capabilities between the two systems. Lists of remote files 50b and local files 50a are displayed in the system. The instructor or student can select a remote file 50b to transfer to the local computer or select a local file 50a to transfer to the remote computer.

Another embodiment of the present invention depicted in FIG. 3 comprises a method of providing synchronized control of the remote mouse pointer 126. The local system initiates the locking of the remote mouse pointer to the movement of the local mouse pointer. Upon mouse movement within the confines of the video window, the local mouse movements sends messages over the network connection to synchronize the remote and local mouse pointers.

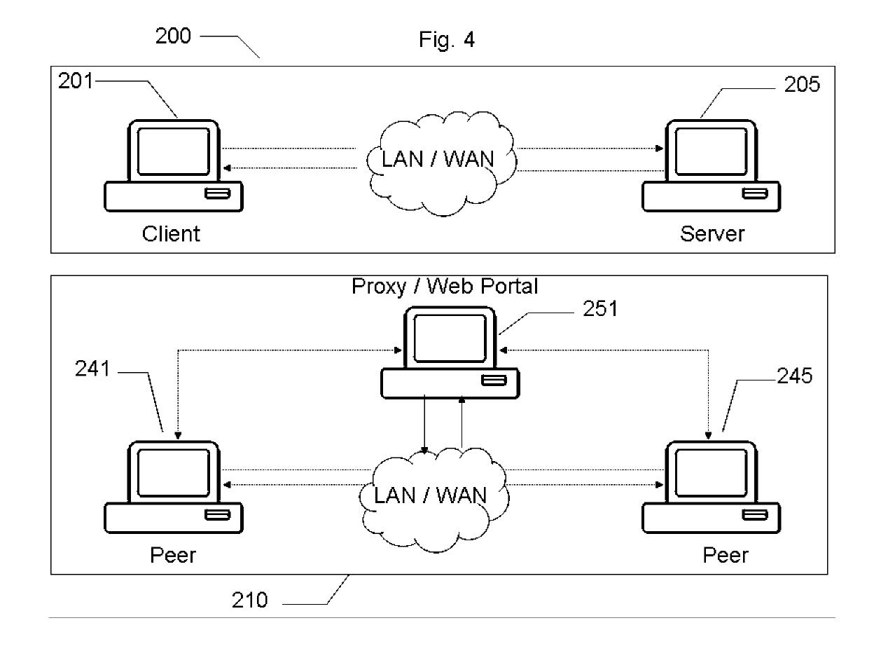

Another embodiment of the present invention depicted in FIG. 4 comprises several methods, generally indicated, for network connectivity of the instructor and student computers through a LAN or WAN. This method comprises of the program on the instructor's computer to act as a server in a client/server architecture 200 and the student's system to act as the client 201. The instructor's system 205 actively listens for the incoming connection from the student's system 201. The student initiates the network connection 25 to the instructor. The instructor's system accepts the connection from the student.

In still another embodiment of the present invention depicted in FIG. 4 comprises a method, general indicated, for network connectivity of the instructor 241 and student 245 computer through a LAN or WAN. This method further comprises that the system for both the instructor 241 and student 245 connect through a proxy server 251. A proxy server 251 is a computer that acts as a gateway to connect computers without either computer knowing the IP address of the other computer.

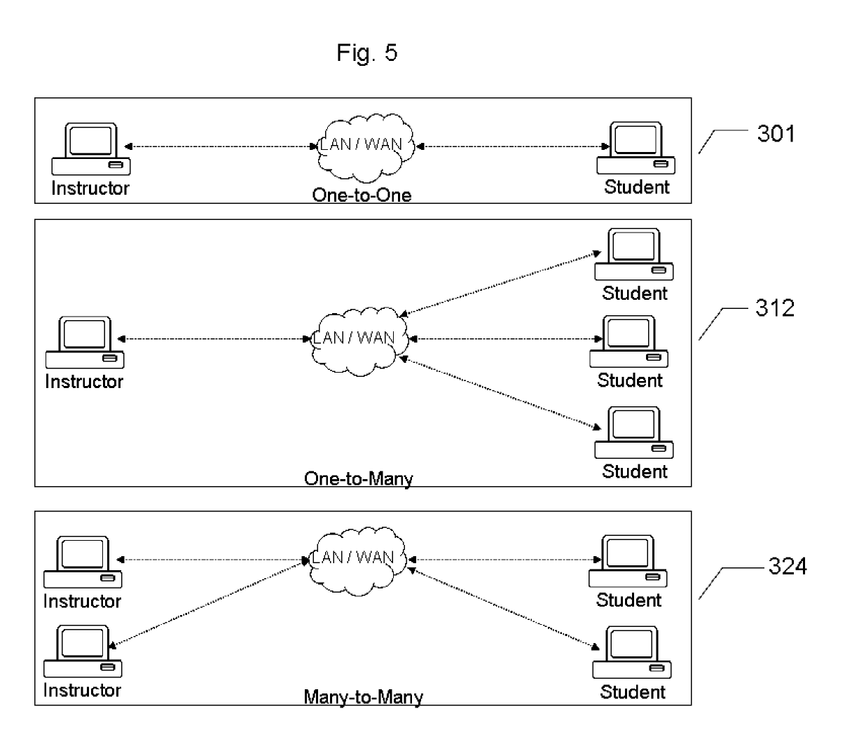

In still another embodiment of the present invention depicted in FIG. 5 comprises of methods for network connection and full collaborative instructional sessions between an instructor and student 301, between an instructor and many students 312 and between many instructors and many students 324.

In still another embodiment of the present invention is to provide a method for a student to select an instructor based on credentials or any other relative criteria. Once selected provide a method to schedule a session with the instructor and collect and remit any associated fees.

Those skilled in the art will note that the order of execution or performance of the methods illustrated and described herein is not essential, unless otherwise specified. That is, it is contemplated by the inventor that elements of the methods may be performed in any order, unless otherwise specified, and that the methods may include more or less elements than those disclosed herein.

When introducing elements of the present invention or the embodiment(s) thereof, the articles “a,” “an,” “the,” and “providing” are indented to mean that there are one or more of the elements. The terms “comprising,” “including,” and “having” are intended to be inclusive and mean that there may be additional elements other than the listed elements.

As various changes could be made in the above system and methods without departing from the scope of the invention, it is intended that all matter contained in the above description and shown in the accompanying drawings shall be interpreted as illustrative and not in a limiting sense.

What is claimed is:

1. A system to provide remote interactive instruction, analysis and collaboration between an instructor and student via a LAN or WAN connection, said system comprising:
a video capture subsystem for capturing video for analysis;
a video presentation subsystem for analysis;
a voice communications technologies for verbal collaboration;
a text messaging technologies for textual based collaboration;
a annotation subsystem to draw shapes, freehand or text on the video;
a file transfer subsystem to send or receive video or data files for analysis; and
a remote control of the mouse pointer in the video window.

2. A system as set forth in claim 1 wherein the video capture subsystem comprises a mechanism for the student to easily capture video from a standard video recording device.

3. A system as set forth in claim 1 wherein the video presentation subsystem provides real-time synchronization of video playback and frame or time positioning between the instructor and student.

4. A system as set forth in claim 1 wherein the voice communications technologies provides real-time verbal communication over an IP network to allow for two-way verbal collaboration between the student and instructor.

5. A system as set forth in claim 1 wherein the text messaging technologies provide two-way text messaging over an IP network to allow textual collaboration between the student and instructor.

6. A system as set forth in claim 1 wherein the annotation subsystem provides two-way real-time synchronization of drawing on video between the student and instructor. Drawings done by the instructor are immediately visible to the student; drawings done by the student are immediately visible to the instructor.

7. A system set forth in claim 1 wherein the file transfer subsystem provides two-way file synchronization for video or data files to be used for analysis. Video file synchronization could consist of transferring the entire video file or parts of the video files down to a single frame.

8. A system set forth in claim 1 wherein remote mouse pointer control can be used by either the student or instructor to point out specifics areas of the video.

9. A system set forth in claim 1 wherein the system will have a user interface that will embody a video window and playback/positioning controls to control the video for the analysis.

10. A system set forth in claim 1 wherein the system will have a user interface that will embody controls for voice collaborations settings.

11. A system set forth in claim 1 wherein the system will have a user interface that will embody controls for textual based collaboration.

12. A system as set forth in claim 1 wherein the system will have a user interface that will embody controls for annotation over video.

13. A system as set forth in claim 1 wherein the system will have a user interface that will embody controls for video and data file transfer.

14. A system as set forth in claim 1 wherein the system will have a user interface the will embody controls for providing remote mouse pointer control.

15. A method for providing a remote interactive instructional session between an instructor and student, with said method comprising one or more but not limited to:
providing a direct network connection between the instructor and the students to support the collaborative technologies needed for the interactive session;
providing a proxy network connection between the instructor and the students to support the collaborative technologies needed for the interactive session;
providing voice collaboration technology to provide verbal communications between the student and instructor or the instructor and multiple students simultaneously;
providing text collaboration technology to provide text messaging between the student and instructor or the instructor and multiple students simultaneously;
providing annotation collaboration technology to provide synchronized drawing capabilities between the student and instructor or the instructor and multiple students simultaneously;
providing video or data capture capabilities for the student to provide video to the instructor for analysis;
providing synchronized video playback and positioning between the student and instructor or the instructor and multiple students simultaneously;
providing video and data file transfer capabilities for the instructor and student to share files for analysis and instructional purposes;
providing remote mouse pointer control for both instructors and students; and
providing selection, scheduling and payment for the instructional session.

16. A method as set forth in claim 15 to provide video or data capture capabilities for the student to provide video to be used by the instructor for analysis.

17. A method as set forth in claim 15 to allow a student to query for an instructor based on credentials or other criteria to select the best instructor for the student.

18. A method as set forth in claim 15 to schedule an interactive instructional session with the desired instructor.

19. A method as set forth in claim 15 to collect and remit fees associated with the interactive instructional sessions.
